(19) United States
(12) Patent Application Publication
(10) Pub. No.: US 2020/0183087 A1
(43) Pub. Date: Jun. 11, 2020

(54) COMPACT OPTICAL CIRCULATOR

(71) Applicant: O-Net Communications (USA) Inc., San Jose, CA (US)

(72) Inventor: Qingdong Guo, San Jose, CA (US)

(21) Appl. No.: 16/705,028

(22) Filed: Dec. 5, 2019

Related U.S. Application Data
(60) Provisional application No. 62/775,870, filed on Dec. 5, 2018.

(51) Int. Cl. G02B 6/27; G02B 27/28; G02B 5/30

(52) U.S. Cl. CPC G02B 6/2746; G02B 5/3083; G02B 27/283

(57) ABSTRACT

Compact optical circulator designs using polarization selective optical elements for versatile applications.

### PRIORITY CLAIM AND RELATED PATENT APPLICATION INFORMATION

This patent document claims priority to and benefits of U.S. Provisional Application No. 62/775,870 entitled “COMPACT OPTICAL CIRCULATOR” filed by Applicant O-Net Communications (USA) Inc. on Dec. 5, 2018.

### TECHNICAL FIELD

This patent document relates to optical devices and techniques for guiding light.

### BACKGROUND

In various optical devices or system, it is sometimes desirable to provide an optical device that can guide light from one optical input/output port to another port in a series of optical input/output ports. For example, a 3-port optical circulator is such a device where light can be routed from the first port to the second port, and from the second port to the third port.

### SUMMARY

This patent document discloses device designs and techniques for constructing compact optical circulators using polarization selective optical elements for versatile applications.

In one aspect, the disclosed technology can be implemented to construct an optical circulator that includes different input/out optical ports, each including (1) a birefringent module for splitting light received at a first side into different light beams of orthogonal optical polarizations to emerge at a second side or combining light beams of orthogonal optical polarizations received at the second side into a single light beam to emerge at the first side, (2) two half-wave plates displaced from each other and located on the second side of the birefringent module to transform two light beams in orthogonal polarizations into two beams of a common polarization, and (3) a Faraday rotator placed to receive light from the two half-wave plates. This optical circulator includes different prisms placed to interface with the different input/out optical ports to exchange light and configured to include at least one angled interface surface between two adjacent prisms that is coated with a polarization beam splitting coating that transmits light at a first optical polarization and reflects light at a second optical polarization that is orthogonal to the first optical polarization. In this optical circulator, the different prisms and the different input/out optical ports are structured to direct light therebetween to cause light to be directed from one input/output optical port to another input/output optical port to effectuate an optical circulator operation.

This and other aspects of the disclosed technology and their implementations are described in greater detail in the drawings, the description and the claims.

### BRIEF DESCRIPTION OF THE DRAWINGS

FIG. 1 shows an example of a 3-port optical circulator with 3 optical ports for receiving and exporting light.

FIGS. 2A and 2B show an example of a 3-port optical circulator using birefringent crystals in combination with other optical components.

FIG. 3 shows another design in which the birefringent crystal block of three birefringent crystals in FIGS. 2A and 2B is replaced by a polarization beam splitting (PBS) prism block of three PBS prisms.

FIGS. 4, 5, 6, 7 and 8 show additional design examples of 3-port optical circulators.

FIG. 9 shows another circulator design which adds two additional right angle prisms based on the design in FIG. 8 so that the beam of light at port 1 and 2 will be reflected and three ports will locate at same side

### DETAILED DESCRIPTION

The device designs and techniques for constructing compact optical circulators disclosed in this patent document can be used to construct multi-port circulators in compact packages for a wide range of optical applications. The specific examples provided here are 3-port optical circulators.

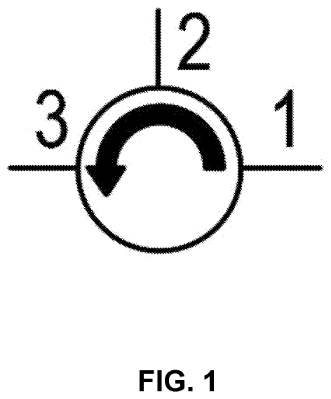

An optical circulator may be used in bi-directional optical transmission by a single fiber line in applications such as an optical fiber communication system. FIG. 1 shows an example of a 3-port optical circulator with 3 optical ports for receiving and exporting light. In implementations of the circulator in FIG. 1, an optical circulator may be constructed as a 3-port non-reciprocal device that redirects light from port 1 to port 2 and from port 2 to port 3.

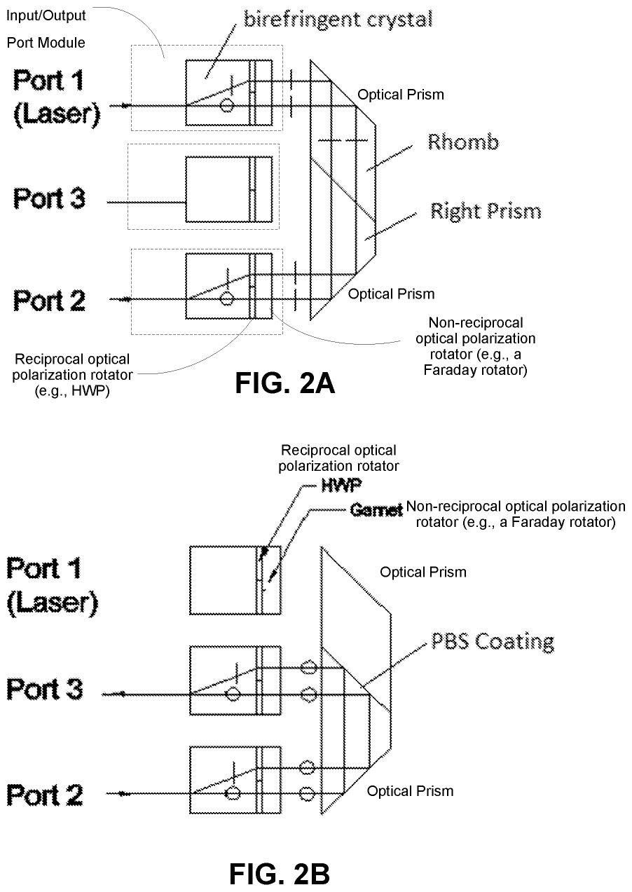

The 3-port optical circulator in FIG. 1 may be implemented, for example, by using optical components shown in the example in FIGS. 2A and 2B. In the illustrated 3-port design, each input/output optical port module includes (1) an optical polarization module for splitting light received at a first side into different light beams of orthogonal optical polarizations to emerge at a second side or combining light beams of orthogonal optical polarizations received at the second side into a single light beam to emerge at the first side, (2) a reciprocal optical rotator module to transform two light beams in orthogonal polarizations into two beams of a common polarization (e.g., two half-wave plates displaced from each other and located on the second side of the birefringent module), and (3) anon-reciprocal optical rotator (a Faraday rotator_placed to receive light from the two half-wave plates.

In the example in FIGS. 2A and 2B, the optical circulator includes a polarization beam splitting/combining block (e.g., a birefringent crystal for splitting light into two beams in orthogonal polarizations and for combining two beams in the orthogonal polarizations into a single beam); a reciprocal optical polarization rotator (e.g., an optical half wave-plate or HWP) and a non-reciprocal optical rotator (e.g., a Faraday Rotator by using a garnet piece such as yttrium iron garnet used near 1.3 and 1.5 microns in wavelength or another material). As illustrated n FIGS. 2A and 2B, those components are used to form different optical input/output ports 1 (upper), 2(bottom) and 3(middle) to interface with a prism module such as a Rhombic prism and a right angle prism to reflect light between the input/output ports 1, 2 and 3. In the example in FIGS. 2A and 2B, the port 1 is positioned to interface with the a Rhombic prism and the ports 2 (bottom) and 3(middle) are positioned to interface with the a right angle prism below the Rhombic prism. In implementations, the polarization beam splitting/combining block may include a birefringent crystal or prism with a polarization beam splitting (PBS) film.

In the operation as shown in FIG. 2A, an incident beam of light from the port 1 on the top is separated by the corresponding birefringent crystal block for the port 1 into two beams having orthogonal directions of polarization (e.g., corresponding to the ordinary “O” and extraordinary ray “E” in birefringent block). Two HWP pieces are attached to the birefringent crystal and are designed to have different optical axis orientations so that one HWP rotates the polarization 45° clockwise and another HWP rotates the polarization 45° counterclockwise. Those two HWP pieces respectively receive the two beams separated by the birefringent crystal block and produce two polarized beams that have same polarization direction after passing the respective HWP. Those two polarization beams produced by the HWP pieces continue to pass the Faraday Rotator and are rotated by 45° in polarization while continuing to propagate in the same direction after the Faraday Rotator. The net rotation effects of two polarization directions are 0 and 90 respectively. The HWP pieces and Faraday Rotator collectively form the first polarization transforming component that renders two orthogonal polarizations parallel to each other.

At this point in the operation in FIG. 2A, the two beams from the port 1 are directed to propagate towards the Rhombic prism, and are to be reflected by an angled facet of the

Rhombic prism. Upon reflection by the angled facet of the Rhombic prism, the two reflected beams continue to propagate in Rhombic prism to enter the PBS (polarization beam splitter) coating formed on another angled facet of the Rhombic prism since polarization of two beam are perpendicular to the plane of incidence (also known as P-polarization). After passing the PBS coating, the two polarization beams enter a right angle prism and are subsequently reflected by the right angle prism in an opposite direction from their initial direction after passing through the port 1 towards the Rhombic prism but are shifted spatially in their positions in that they are now directed to the port 2 on the bottom below the port 3 in the middle. Two beam polarization direction remain unchanged when beams enter rhombic prism and exit right angle prism.

Next at the port 2 on the bottom in FIG. 2A, the two reflected beams enter the second polarization transforming component for the port 2. Similarly, a beam polarization is rotated 0° and another beam is rotated 90°. The second polarization transforming component renders two parallel polarizations perpendicular to each other. Two beams subsequently pass through a second birefringent crystal block in the port 2, where a beam is the extraordinary ray and another beam is ordinary. The second birefringent block combines “O” and “E” beams to form a single beam as the output at port 2.

FIG. 2B is a schematic of the optical circulator showing another operation for incident light to enter the circulator at Port 2 and to exit at the Port 3. The beam of light entering the port 2 is separated by the birefringent crystal block in Port 2 into two beams having orthogonal directions of polarization, corresponding to the ordinary “O” and extraordinary ray “E” in the birefringent crystal block. Two HWP (Half Wave-Plate) attached to the birefringent crystal in Port 2 are designed to have different optical axis orientations, similar to the construction in Port 1. One HWP rotates the polarization 45° clockwise and another HWP rotates the polarization 45° counterclockwise. Two polarized beams have same polarization direction after passing HWP. Two polarization beams continue to pass Faraday Rotator and continue to be rotated 45° with same direction by Faraday Rotator. The net rotation effects of two polarization are 0° and 90° respectively.

In FIG. 2B, the two beams coming out of the port 2 towards the right angle prism are reflected by the lower (bottom) angled facet of the right angle prism towards its upper angled facet with the PBS coating. The reflected beams from the port 2 by the lower angled facet of the right angled prim propagate upwards to reach the upper angled facet with the PBS coating where the polarization of the two beams are perpendicular to the incidence plane of PBS (also known as S-polarization). Two polarization beams subsequently reflected by the PBS coating of the upper angled facet towards the port 3 while its polarizations remain at the polarization direction unchanged.

Next in the operation in FIG. 2B, the two beams reflected by the right angled prism enter the third polarization transforming component for port 3. Similarly, a beam polarization is rotated 0° and another beam is rotated 90°. The third polarization transforming component renders two parallel polarizations perpendicular to each other. Two beams subsequently pass through a third birefringent block, where a beam is the extraordinary ray and another beam is ordinary. That third birefringent block combines “O” and “E” beams to form a single beam at port 3.

In a reverse transmission from port 3 to port 2, the polarization direction of two beams will be perpendicular to incidence plane of PBS coating after passing third transforming component (rotator). Therefore, two beams will pass PBS coating and can't get into port 2. Similarly, from port 2 to port 1, two beams will be reflected at PBS coating and go to port 3 rather than port 1.

The above optical circulator design in FIGS. 2A and 2B can be implemented in a compact device package based the folded optical paths and the sharing of the right angled prism with a PBS coating at the interface with the Rhombic prism.

In addition, the above optical circulator design in FIGS. 2A and 2B may be modified to provide optical circulators in other configurations.

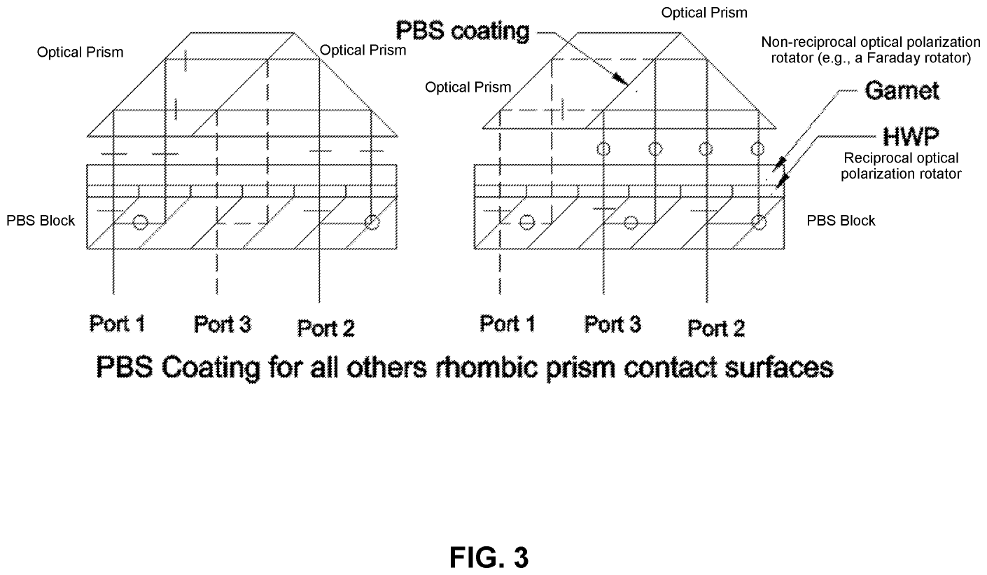

FIG. 3 shows another design in which the birefringent crystal block of three birefringent crystals in FIGS. 2A and 2B is replaced by a polarization beam splitting (PBS) prism block of three PBS prisms. In FIG. 3, the function of polarization beam splitting prism assembly is same with birefringent crystal block. There is a polarization splitting coating on contact surface of rhombic prism. The prism assembly can separate an incident beam of light into two beams having orthogonal directions of polarization. The beam traveling, and polarization transferring show in FIG. 3. It is similar showing in the first embodiment in FIGS. 2A and 2B.

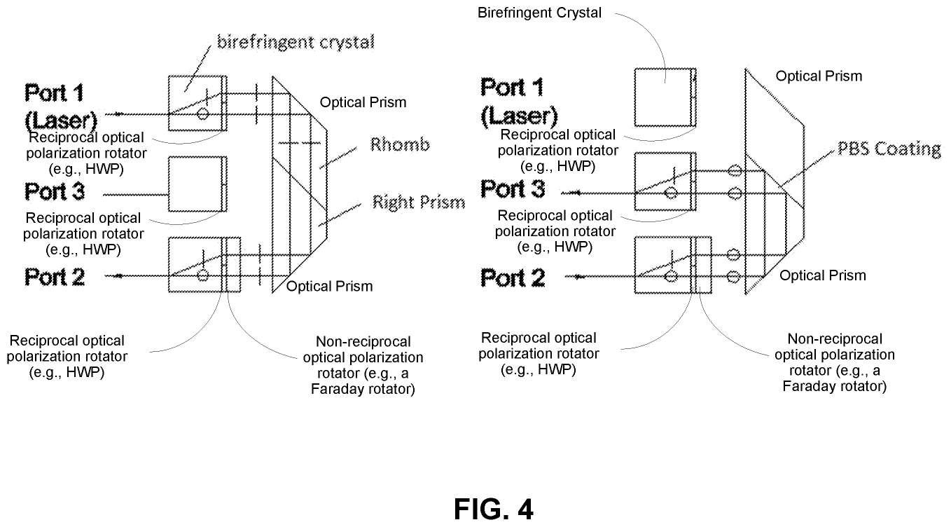

In FIG. 3, the Faraday rotators at port 1 and port 3 can be removed, but HWP optical axis orientation can be changed to ensure the polarization of two beams staying same as shown in FIG. 4. In FIG. 4, the first and second input/out optical port modules on the top (as ports 1 and 3) are similarly constructed to include (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization. The third input/out optical port module on the bottom for port 2 is different from the first and second input/out optical port modules and includes (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization, and (3) a Faraday rotator placed to receive light from the two half-wave plates.

In the design in FIG. 4, the circulator has the same function of redirecting light from port 1 to port 2 and from port 2 to port 3 as in the design in FIGS. 2A and 2B. But the circulator design in FIG. 4 has a lower optical isolation since it is single stage which removes light with wrong polarization off path at the PBS coating only. Two stage circulators can continue to remove light with wrong polarization off path before two polarization beams are combined by the birefringence crystal.

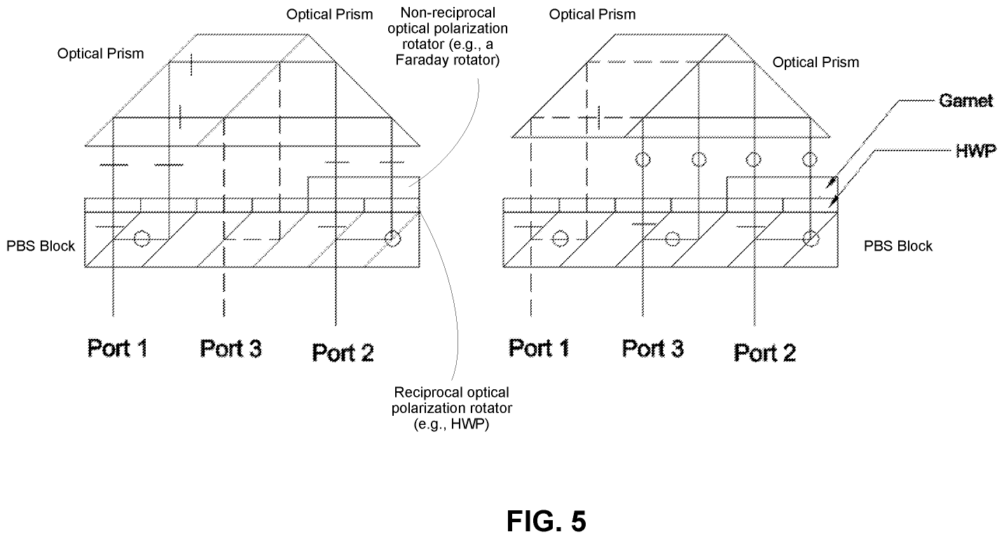

In implementations, a single stage circulator can be constructed with a polarization beam splitting prism assembly instead of birefringence crystals as shown in the example in FIG. 5.

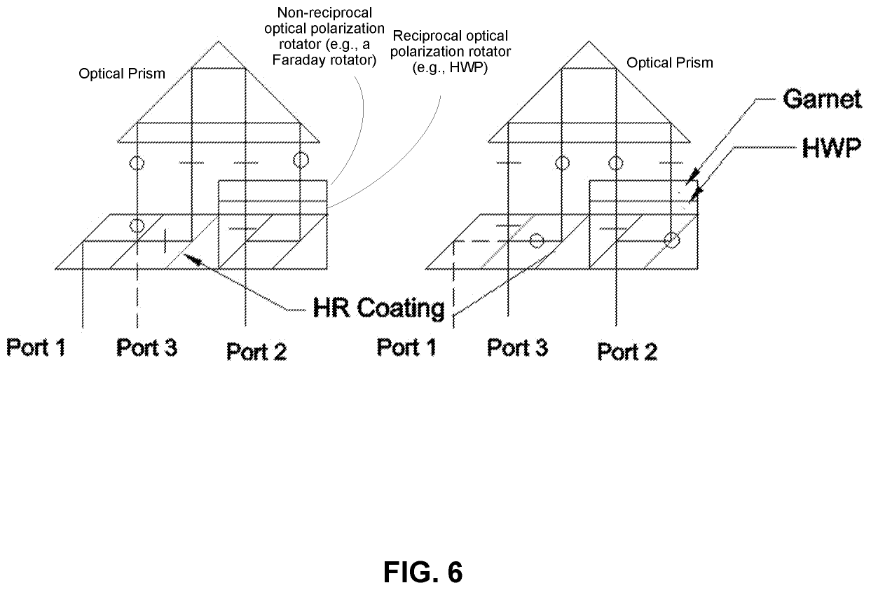

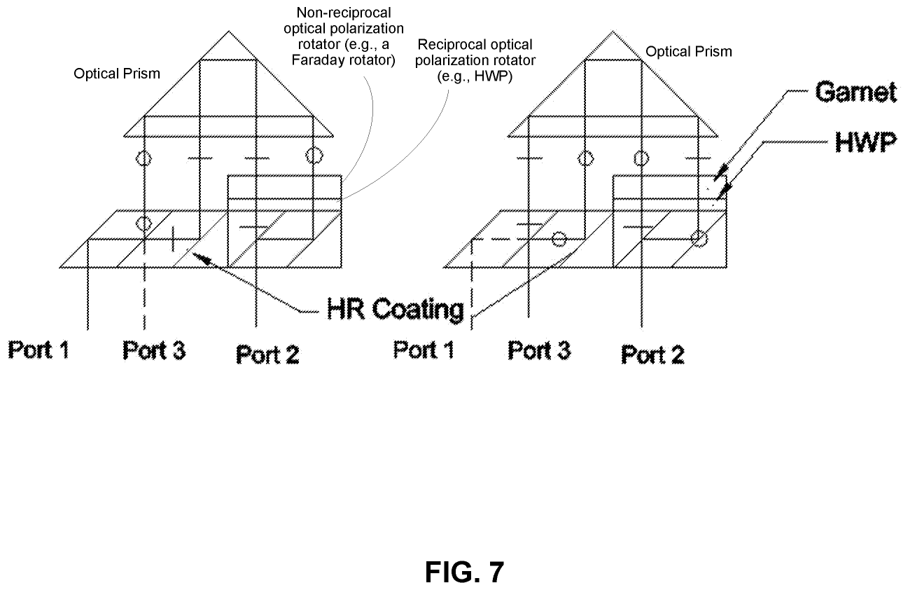

FIGS. 6 and 7 show another design of a 3-port optical circulator. The optical axis orientation of HWP is directed in the same direction when two beams having orthogonal directions of polarization pass through. So the net rotation effects of two polarization beam divided by PBS will be same after passing polarization transforming component. Single and dual stage circulator shown in FIG. 6 and FIG. 7. In various implementations, the Rhombic prism contact surfaces may have PBS coating.

The example in FIGS. 6 and 7 represents a class of optical circulators that include an input/out optical port module with the following five optical reflective surfaces: (1) a first angled optical reflective surface forming a first optical input/output port, (2) a second angled optical reflective surface that is adjacent to and parallel to the first angled optical reflective surface and is a polarization selective reflective surface as a third optical input/output port, (3) a third angled optical reflective surface that is parallel to the first and second angled optical reflective surfaces and is a polarization selective reflective surface as a second optical input/output port, (4) a fourth optical reflective surface that is located between the second and the third angled optical reflective surfaces, and is parallel to the first, second and third angled optical reflective surfaces to reflect light in both the first and second optical polarizations, (5) a fifth angled optical reflective surface that is adjacent to and parallel to the third angled optical reflective surface but is located on an opposite of thee fourth angled optical reflective surface with respect to the fourth angled optical reflective surface. Such a circulator further includes an optical prism placed relative to the input/out optical port module to exchange light therewith and configured to reflect light back and forth between the first and fifth optical reflective surfaces, to reflect light back and forth between the third and fourth optical reflective surfaces; a half-wave plate located in the optical paths for light for the fourth and fifth optical reflective surfaces with respect to the optical prism; and a Faraday rotator located in the optical paths for light for the fourth and fifth optical reflective surfaces with respect to the optical prism so that light traveling between the optical prism and the input/out optical port module via the fourth and fifth optical reflective surfaces passes through both the half-wave plate and the Faraday rotator.

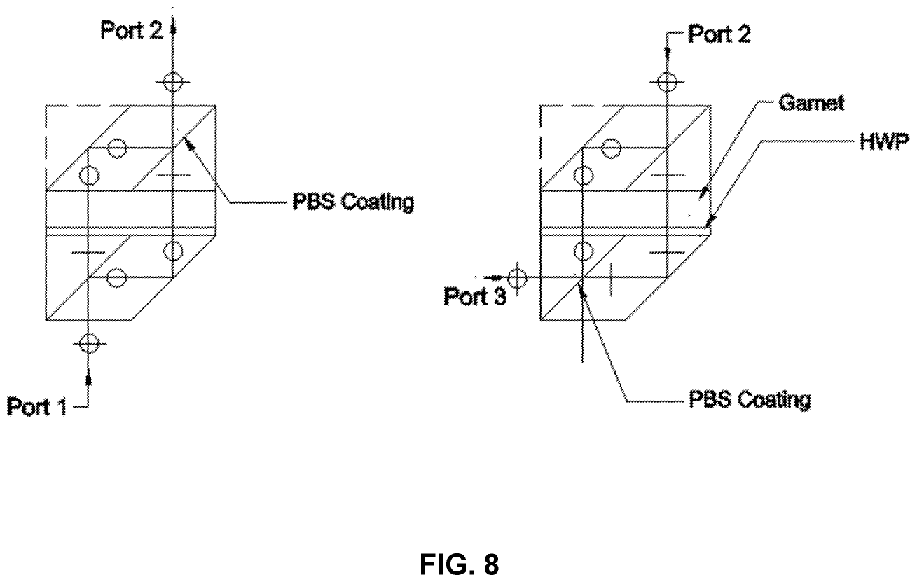

FIG. 8 shows yet another optical circulator design based on a single stage circulator design. The prism drawn by dash line use to improve polarization extinction ratio (PER) of reflection beam by PBS coating. It can be removed if PER of reflection beam is sufficiently high for an intended application.

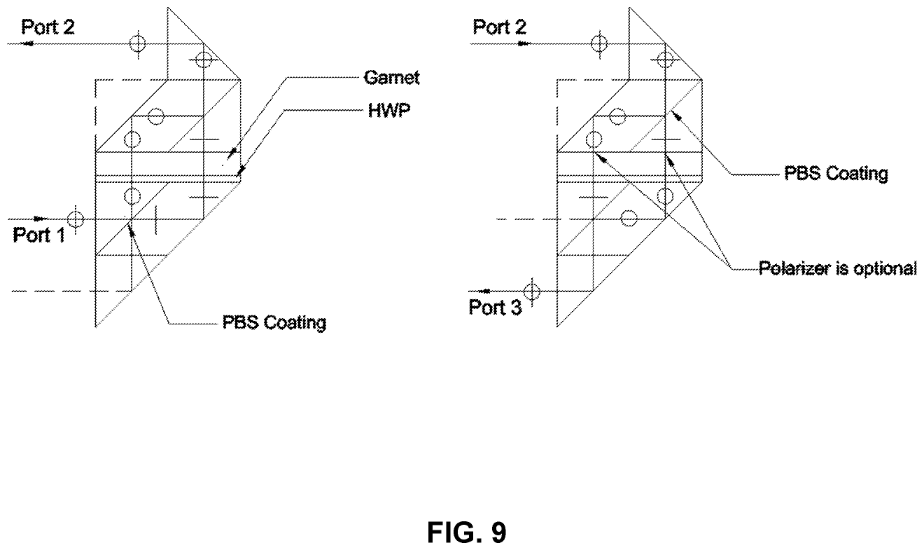

FIG. 9 shows another circulator design which adds two additional right angle prisms based on the design in FIG. 8 so that the beam of light at port 1 and 2 will be reflected and three ports will locate at same side.

The examples in FIGS. 8 and 9 represent a class of optical circulators with 3 ports that include a half-wave plate; a Faraday rotator located adjacent to the half-wave plate and structured to include a first optical surface interfacing with the half-wave plate and a second optical surface opposite to the first optical surface; and a first and second optical modules located on the two sides of the HWP and Faraday rotator. The first optical module is located to interface with the half-wave plate and structured to include first and second angled optical reflective surfaces that are parallel to and displaced from each other at or near 45 degrees with respect to the half-wave plate and the first angled optical reflective surface reflects light in a first optical polarization while transmitting light in a second optical polarization orthogonal to the first optical polarization and is oriented to reflect light reflected from the second angled optical reflective surface to be away from the half-wave plate and the Faraday rotator. The second optical module is located to interface with the Faraday rotator and structured to include third and fourth angled optical reflective surfaces that are parallel to and displaced from each other at or near 45 degrees with respect to a surface of the Faraday rotator. The third angled optical reflective surface is spatially positioned to exchange light with the first angled optical reflective surface, and the fourth angled optical reflective surface is spatially positioned to receive reflected light from the second angled optical reflective surface and is structured to reflect reflects light in the first optical polarization while transmitting light in the second optical polarization. The first angled optical reflective surface forms first and third optical input/output ports of the optical circulator and the third angled optical reflective surface forms a second optical input/output port of the optical circulator to enable light to circulate from the first input/output port, to the second input/output port and to the third input/output port.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described and other implementations, enhancements and variations can be made based on what is described and illustrated in this patent document.

What is claimed is what is described and illustrated, including:

1. An optical circulator, comprising:
different input/out optical port modules, each including (1) an optical polarization module for splitting light received at a first side into different light beams of orthogonal optical polarizations to emerge at a second side or combining light beams of orthogonal optical polarizations received at the second side into a single light beam to emerge at the first side, (2) two half-wave plates displaced from each other and located on the second side of the birefringent module to transform two light beams in orthogonal polarizations into two beams of a common polarization, and (3) a Faraday rotator placed to receive light from the two half-wave plates; and
different prisms placed relative to the different input/out optical port modules to interface with the different input/out optical port modules to exchange light and configured to include at least one angled interface surface between two adjacent prisms that is coated with a polarization beam splitting coating that transmits light at a first optical polarization and reflects light at a second optical polarization that is orthogonal to the first optical polarization,
wherein the different prisms and the different input/out optical port modules are structured to direct light therebetween to cause light to be directed from one input/output optical port to another input/output optical port to effectuate an optical circulator operation.

2. The optical circulator as in claim 1, wherein the two half-wave plates in each input/out optical port module have different optical axis orientations so that one of the two half-wave plates rotates the polarization 45° in one direction and another of the two half-wave plates rotates the polarization 45° in an opposite direction.

3. The optical circulator as in claim 1, wherein an optical polarization module in the input/out optical port modules includes a birefringent crystal.

4. The optical circulator as in claim 1, wherein an optical polarization module in the input/out optical port modules includes a polarization beam splitting (PBS) device.

5. The optical circulator as in claim 1, wherein the different prisms include a first prism in an optical path of a first input/out optical port module, and a second prism in optical paths of the second and third adjacent input/out optical port modules.

6. An optical circulator, comprising:
a first input/out optical port module including (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization;
a second input/out optical port module similarly constructed as the first input/out optical port module and including (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization;
a third input/out optical port module different from the first and second input/out optical port modules and including (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization, and (3) a Faraday rotator placed to receive light from the two half-wave plates;
a first prism placed relative to the first input/out optical port module to exchange light therewith and configured to include at least one angled interface; and
a second prism placed relative to the second and third input/out optical port modules to exchange light therewith;
wherein the first and second prisms include at least one angled interface surface between the first and second prisms that is coated with a polarization beam splitting coating that transmits light at a first optical polarization and reflects light at a second optical polarization that is orthogonal to the first optical polarization, and
wherein the first and second prisms and the first, second and third input/out optical port modules are structured to direct light therebetween to cause light to be directed from one input/output optical port to another input/output optical port to effectuate an optical circulator operation.

7. The optical circulator as in claim 6, wherein the two half-wave plates in each input/out optical port module have different optical axis orientations so that one of the two half-wave plates rotates the polarization 45° in one direction and another of the two half-wave plates rotates the polarization 45° in an opposite direction.

8. The optical circulator as in claim 6, wherein an optical polarization module in one of the input/out optical port modules includes a birefringent crystal.

9. The optical circulator as in claim 1, wherein an optical polarization module in one of the input/out optical port modules includes a polarization beam splitting (PBS) device.

10. An optical circulator, comprising:
a first input/out optical port module including (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization;
a second input/out optical port module similarly constructed as the first input/out optical port module and including (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization;
a third input/out optical port module different from the first and second input/out optical port modules and including (1) an optical polarization module for splitting light received at a first side into different light beams of orthogonal optical polarizations to emerge at a second side or combining light beams of orthogonal optical polarizations received at the second side into a single light beam to emerge at the first side, and (2) two half-wave plates displaced from each other and located on the second side of the birefringent module to transform two light beams in orthogonal polarizations into two beams of a common polarization, and (3) a Faraday rotator placed to receive light from the two half-wave plates;
a first prism placed relative to the first input/out optical port module to exchange light therewith and configured to include at least one angled interface; and
a second prism placed relative to the second and third input/out optical port modules to exchange light therewith;
wherein the first and second prisms include at least one angled interface surface between the first and second prisms that is coated with a polarization beam splitting coating that transmits light at a first optical polarization and reflects light at a second optical polarization that is orthogonal to the first optical polarization, and
wherein the first and second prisms and the first, second and third input/out optical port modules are structured to direct light therebetween to cause light to be directed from one input/output optical port to another input/output optical port to effectuate an optical circulator operation.

11. The optical circulator as in claim 10, wherein the two half-wave plates in each input/out optical port module have different optical axis orientations so that one of the two half-wave plates rotates the polarization 45° in one direction and another of the two half-wave plates rotates the polarization 45° in an opposite direction.

12. The optical circulator as in claim 10, wherein an optical polarization module in one of the input/out optical port modules includes a birefringent crystal.

13. The optical circulator as in claim 10, wherein an optical polarization module in one of the input/out optical port modules includes a polarization beam splitting (PBS) device.

14. An optical circulator, comprising:
an input/out optical port module including (1) a first angled optical reflective surface forming a first optical input/output port, (2) a second angled optical reflective surface that is adjacent to and parallel to the first angled optical reflective surface and is a polarization selective reflective surface as a third optical input/output port, (3) a third angled optical reflective surface that is parallel to the first and second angled optical reflective surfaces and is a polarization selective reflective surface as a second optical input/output port, (4) a fourth optical reflective surface that is located between the second and the third angled optical reflective surfaces, and is parallel to the first, second and third angled optical reflective surfaces to reflect light in both the first and second optical polarizations, (5) a fifth angled optical reflective surface that is adjacent to and parallel to the third angled optical reflective surface but is located on an opposite of thee fourth angled optical reflective surface with respect to the fourth angled optical reflective surface;
an optical prism placed relative to the input/out optical port module to exchange light therewith and configured to reflect light back and forth between the first and fifth optical reflective surfaces, to reflect light back and forth between the third and fourth optical reflective surfaces;
a half-wave plate located in the optical paths for light for the fourth and fifth optical reflective surfaces with respect to the optical prism; and
a Faraday rotator located in the optical paths for light for the fourth and fifth optical reflective surfaces with respect to the optical prism so that light traveling between the optical prism and the input/out optical port module via the fourth and fifth optical reflective surfaces passes through both the half-wave plate and the Faraday rotator.

15. An optical circulator, comprising:
a half-wave plate;
a Faraday rotator located adjacent to the half-wave plate and structured to include a first optical surface interfacing with the half-wave plate and a second optical surface opposite to the first optical surface;
a first optical module located to interface with the half-wave plate and structured to include first and second angled optical reflective surfaces that are parallel to and displaced from each other at or near 45 degrees with respect to the half-wave plate, wherein the first angled optical reflective surface reflects light in a first optical polarization while transmitting light in a second optical polarization orthogonal to the first optical polarization and is oriented to reflect light reflected from the second angled optical reflective surface to be away from the half-wave plate and the Faraday rotator; and
a second optical module located to interface with the Faraday rotator and structured to include third and fourth angled optical reflective surfaces that are parallel to and displaced from each other at or near 45 degrees with respect to a surface of the Faraday rotator, wherein the third angled optical reflective surface is spatially positioned to exchange light with the first angled optical reflective surface, and the fourth angled optical reflective surface is spatially positioned to receive reflected light from the second angled optical reflective surface and is structured to reflect reflects light in the first optical polarization while transmitting light in the second optical polarization,
wherein the first angled optical reflective surface forms first and third optical input/output ports of the optical circulator and the third angled optical reflective surface forms a second optical input/output port of the optical circulator to enable light to circulate from the first input/output port, to the second input/output port and to the third input/output port.
